(19) United States
(12) Patent Application Publication
(10) Pub. No.: US 2017/0294021 A1
(43) Pub. Date: Oct. 12, 2017

(54) DEPTH REFINEMENT METHOD AND SYSTEM OF SPARSE DEPTH IMAGE IN MULTI-APERTURE CAMERA

(71) Applicant: CENTER FOR INTEGRATED SMART SENSORS FOUNDATION, Daejeon (KR)

(72) Inventors: Muhammad Umar Karim Khan, Daejeon (KR); Chong Min KYUNG, Daejeon (KR)

(21) Appl. No.: 15/146,592

(22) Filed: May 4, 2016

(30) Foreign Application Priority Data
Apr. 11, 2016 (KR) 10-2016-0044190

(51) Int. Cl. G06T 7/00; G06T 5/00

(52) U.S. Cl. CPC G06T 7/0051; G06T 7/0085; G06T 5/002; G06T 2207/10148

(57) ABSTRACT

Disclosed are a depth refinement system and a method for a sparse depth image in a multi-aperture camera. The method includes providing a sparse depth map generated based on an image obtained through each of a plurality of apertures included in the multi-aperture camera, wherein the sparse depth map includes depths of pixels included in the image, and performing a depth noise reduction (DNR) based on the sparse depth map.

### CROSS-REFERENCE TO RELATED APPLICATIONS

A claim for priority under 35 U.S.C. §119 is made to Korean Patent Application No. 10-2016-0044190 filed Apr. 11, 2016, in the Korean Intellectual Property Office, the entire contents of which are hereby incorporated by reference.

### BACKGROUND

Embodiments of the inventive concept described herein relate to a depth refinement system for a sparse depth image in a multi-aperture camera and a method thereof, and more particularly, relate to a technique of refining each depth of pixels included in an image based on a sparse depth map generated based on an image obtained through each of plural apertures of a multi-aperture camera.

A sparse depth map including depths of pixels included in an image may be generated in many depth determining schemes. For example, referring to FIG. 1 that shows a multi-aperture camera system according to the related art, the multi-aperture camera system 100 includes an image capture stage 110 and an image processing stage 120 for depth determination.

The image capture state 110 includes a lens 111, a plurality of apertures 112, and an image sensor 113. The image processing stage 120 includes a sparse depth map extraction system 121 for generating a sparse depth map based on an image obtained through each aperture 112 included in the image capture stage 110.

In this case, although not shown, the image capture stage 110 may further include a shutter and a color filter array as well as the image sensor 113. The image processing stage 120 may further include a color interpolation/noise reduction unit.

Thus, the sparse depth map extraction system 121 may determine depths of pixels included in an image based on blur variation of the images obtained through each of the apertures 112 having mutually different sizes, such that the sparse depth map extraction system 121 generates a sparse depth map including the depths of pixels.

However, the depths of pixels included in the sparse depth map generated as described above are imprecise due to a noise, an alignment error between the images obtained through each aperture 112 or a structural error of the multi-aperture camera system 100.

Therefore, there is a need to provide a technique of refining depths of pixels included in a sparse depth map.

### SUMMARY

Embodiments of the inventive concept provide a technique capable of refining depths of pixels included in a sparse depth map by reducing a noise based on the sparse depth map.

In detail, embodiments of the inventive concept provide a technique capable of refining depths of pixels based on at least one of neighborhoods of pixels, the surface shape of an object at which an edge segment including pixels, depth ensembles between pixels on the same surface, and three-dimensional characteristics of an object.

As described above, embodiments of the inventive concept provide a technique capable of reducing a noise by using perception cues based on a sparse depth map.

One aspect of embodiments of the inventive concept is directed to provide a method of refining depths of sparse depth images in a multi-aperture camera, which includes providing a sparse depth map generated based on an image obtained through each of a plurality of apertures included in the multi-aperture camera, wherein the sparse depth map includes depths of pixels included in the image, and performing a depth noise reduction (DNR) based on the sparse depth map, wherein the performing of the DNR includes at least one of refining the depths of pixels based on neighborhoods of the pixels included in the image, wherein the neighborhoods are values about depths of neighborhood pixels adjacent to the pixels, refining depths of pixels included in an edge segment based on a surface shape of an object at which the edge segment included in the image is located, refining depths of pixels included in a same surface based on depth ensembles in the pixels included in the same surface of the object, and refining the depths of pixels included in the edge segment which is located at the object based on three-dimensional characteristics of the object.

The providing of the depths of pixels may include detecting the neighborhood of the pixels included in the image, and applying a local or global manner to the depths of pixels based on the detected neighborhoods to refine the depths of pixels.

The detecting of the neighborhoods of the pixels included in the image may include estimating the neighborhoods of the pixels based on at least one of an average, a weighted average value, and a majority-voting value of the depths of the pixels and the neighborhood pixels.

The refining of the depths of pixels based on the surface shape of the object may include detecting the edge segment in the image, applying a regression scheme based on an equation related to a curved surface and an equation related to a planer surface to generate a model of a surface on which the edge segment is located, and refining the depths of the pixels included in the edge segment based on the model.

The refining of the depths of pixels based on depth ensembles may include detecting an occlusion T-junction representing a butt region of the edge segment in the image, setting all edge segments connected to a butting edge segment in the occlusion T-junction as a first edge segment located on the same surface, setting all edge segments connected to a butted edge segment in the occlusion T-junction as a second edge segment located on another same surface, refining depths of pixels included in the first edge segment based on depth ensembles in each pixel included in the first edge segment, and refining depths of pixels included in the second edge segment based on depth ensembles of each pixel included in the second edge segment.

The detecting of the occlusion T-junction may include comparing depths of pixels included in the butted and butting edge segments in the occlusion T-junction with each other to determine the occlusion T-junction.

The setting of the edge segments as the first edge segment may include setting all edge segments connected to the butting edge segment as the first edge segment, based on space connectivity and similarity of the butting edge segment in the occlusion T-junction.

The setting of the edge segments as the second edge segment may include setting all edge segments connected to the butted edge segment as the second edge segment located on the another same surface, based on space connectivity and similarity of the butted edge segment in the occlusion T-junction.

The refining of the depths of pixels based on the three-dimensional characteristics of the object may include detecting a vertex of the object in the image, selecting one from edge segments connected to the vertex, and refining depths of pixels included in the at least one edge segment based on a surface model of the object formed of the edge segments connected to the vertex.

The surface model may be modeled based on an equation related to a curved surface and an equation related to a planer surface.

Another aspect of embodiments of the inventive concept is directed to provide a system for refining depths of sparse depth images in a multi-aperture camera, which includes a sparse depth map providing unit configured to provide a sparse depth map generated based on an image obtained through each of a plurality of apertures included in the multi-aperture camera, wherein the sparse depth map includes depths of pixels included in the image, and a DNR performing unit configured to perform a depth noise reduction (DNR) based on the sparse depth map, wherein the DNR performing unit includes at least one of a first DNR performing unit configured to refine the depths of pixels based on neighborhoods of the pixels included in the image, wherein the neighborhoods are values about depths of neighborhood pixels adjacent to the pixels, a second DNR performing unit configured to refine depths of pixels included in an edge segment based on a surface shape of an object at which the edge segment included in the image is located, a third DNR performing unit configured to refine depths of pixels included in a same surface based on depth ensembles in the pixels included in the same surface of the object, and a fourth DNR performing unit configured to refine the depths of pixels included in the edge segment which is located at the object based on three-dimensional characteristics of the object.

The first DNR performing unit may detect the neighborhood of the pixels included in the image and applies a local or global manner to the depths of pixels based on the detected neighborhood to refine the depths of pixels.

The second DNR performing unit may detect the edge segment in the image, applies a regression scheme based on an equation related to a curved surface and an equation related to a planer surface to generate a model of a surface on which the edge segment is located, and refines the depths of the pixels included in the edge segment based on the model.

The third DNR performing unit may detect an occlusion T-junction representing a butt region of the edge segment in the image, sets all edge segments connected to a butting edge segment in the occlusion T-junction as a first edge segment located on the same surface, sets all edge segments connected to a butted edge segment in the occlusion T-junction as a second edge segment located on another same surface, refines depths of pixels included in the first edge segment based on depth ensembles in each pixel included in the first edge segment, and refines depths of pixels included in the second edge segment based on depth ensembles in each pixel included in the second edge segment.

The fourth DNR performing unit may detect a vertex of the object in the image, selects one among edge segments connected to the vertex, and refines depths of pixels included in the at least one edge segment based on a surface model of the object formed as the edge segments connected to the vertex.

### BRIEF DESCRIPTION OF THE FIGURES

The above and other objects and features will become apparent from the following description with reference to the following figures, wherein like reference numerals refer to like parts throughout the various figures unless otherwise specified, and wherein

FIG. 1 is a view illustrating a multi-aperture camera system according to the related art.

FIG. 2 is a view illustrating a multi-aperture camera system according to an embodiment.

FIG. 3 is a flowchart illustrating an operation of a first DNR (depth noise reduction) operating unit included in a DNR performing unit according to an embodiment.

FIG. 4 is a view illustrating an edge segment for the purpose of describing a second DNR performing unit included in the DNR performing unit according to an embodiment.

FIG. 5 is a flowchart illustrating an operation of a second DNR performing unit according to an embodiment.

FIG. 6 is a view illustrating an edge segment for the purpose of describing the operation of a third DNR performing unit included in the DNR performing unit according to an embodiment.

FIG. 7 is a flowchart illustrating an operation of a third DNR performing unit according to an embodiment.

FIG. 8 is a view illustrating a third-dimensional object for the purpose of describing a fourth DNR performing unit included in the DNR performing unit according to an embodiment.

FIG. 9 is a flowchart illustrating an operation of a fourth DNR performing unit according to an embodiment

FIG. 10 is a flowchart illustrating a depth refinement method according to an embodiment.

FIG. 11 is a block diagram illustrating a depth refinement system according to an embodiment.

### DETAILED DESCRIPTION

Hereinafter, the embodiments will be described in detail with reference accompanying drawings. However, the embodiments are not limited to the disclosure. In addition, the same reference numerals denote the same elements throughout the disclosure.

In addition, terminologies to be described are defined based on functions of components according to the embodiments, and may have meanings varying according to the intentions of a user or an operator and customers. Accordingly, the terminologies should be defined based on the whole context throughout the present disclosure.

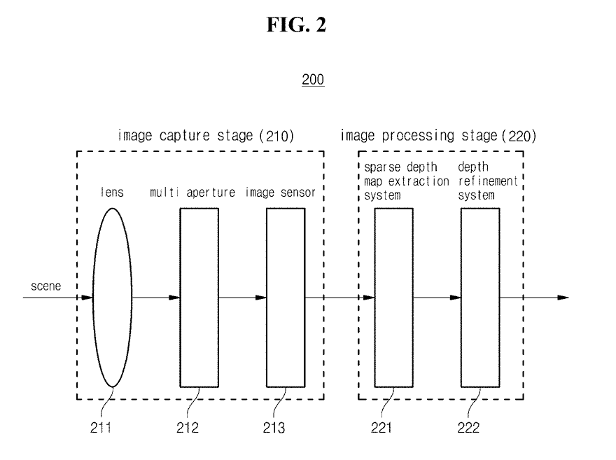

FIG. 2 is a view illustrating a multi-aperture camera system according to an embodiment.

Referring to FIG. 2, the multi-aperture camera system 200 includes an image capture stage 210 and an image processing stage 220 for determining and refining a depth.

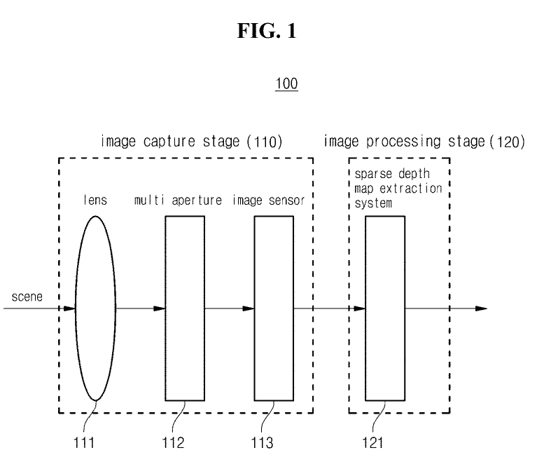

In this case, the image capture stage 210 may include a lens 211, a plurality of apertures 212 and an image sensor 213, and may perform the same operation as that of the multi-aperture camera system described with reference to FIG. 1. In addition, the image capture camera system may further include a shutter and a color filter array.

The image processing stage 220 includes a sparse depth map extraction system 221 for generating a sparse depth map based on an image obtained through the apertures 212 included in the image capture stage 210 and a depth refinement system 222.

In this case, the sparse depth map extraction system 221 may perform an operation of generating a sparse depth map identically with the sparse depth map extraction system described with reference to FIG. 1. The generated sparse depth map is transferred to the depth refinement system 222. Likewise, the image processing stage 220 may further include a color interpolation/noise reduction unit.

The depth refinement system 222 includes a sparse depth map providing unit (not shown) to which the spars depth map is provided from the sparse depth map extraction system 221 and a DNR performing unit (not shown) for performing depth noise reduction (DNR).

Thus, the depth refinement system 222 may adaptively perform four DNR steps using perception cues based on the sparse depth map through the DNR performing unit.

For example, the depth refinement system 222 may adaptively perform at least one of a first DNR step of refining the depths of pixels based on neighborhoods of the pixels included in the image, wherein the neighborhoods are values about depths of neighborhood pixels adjacent to the pixels, a second DNR step of refining depths of pixels included in an edge segment based on a surface shape of an object at which the edge segment included in the image is located, a third DNR step of refining depths of pixels included in a same surface based on depth ensembles in the pixels included in the same surface of the object, and a fourth DNR step of refining the depths of pixels included in the edge segment which is located at the object based on three-dimensional characteristics of the object.

In detail, for example, the DNR performing unit may include at least one of the first to fourth DNR performing units, such that the DNR performing unit performs at least one of the operations of the first to fourth DNR steps of the first to fourth DNR performing units.

Specifically, the DNR performing unit may independently perform only one of the four DNR steps or a combination of at least two of the four DNR steps, such that the depth qualities of the pixels included in the sparse depth map are improved (when the DNR performing unit performs a combination of some of the four DNR steps, the DNR performing unit includes elements corresponding the performed steps of the first to fourth DNR performing units).

For example, the DNR performing unit includes all the first to fourth DNR performing units such that the DNR performing unit performs a combination of all the first to fourth DNR steps.

The operations performed by each of the first to fourth DNR performing units included in the DNR performing unit will be described in detail below.

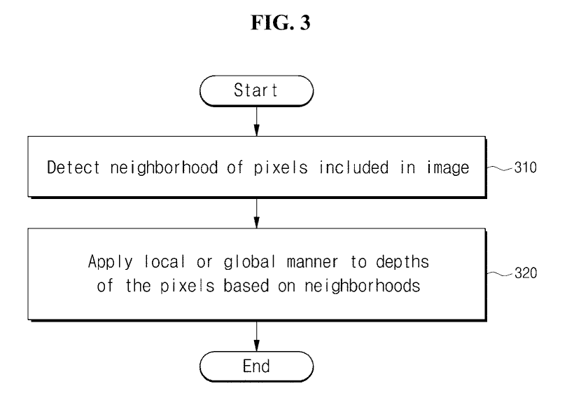

FIG. 3 is a flowchart illustrating the operation of the first DNR performing unit included in the DNR performing unit according to an embodiment.

Referring to FIG. 3, the first DNR performing unit included in the DNR performing unit according to an embodiment refines the depths of pixels based on neighborhoods of the pixels included in the image.

In detail, after detecting neighborhoods of the pixels included in the image in step 310, the first DNR performing unit may apply a local or global manner to the depths of pixels based on the detected neighborhoods to refine the depths of pixels in step 320.

For example, the first DNR performing unit may detect the neighborhood of the pixels by estimating the neighborhoods of the pixels based on at least one of an average, a weighted average value, and a majority-voting value of the depths of the pixels.

Thus, the first DNR performing unit may more exactly refine the depths of pixels by applying the local or global manner to each pixel based on the estimated neighborhoods as described above.

In more detail, for example, the first DNR performing unit may refine the depths of pixels by amending the depths of pixels with reference to the local or global neighborhoods of the pixels.

In addition, the first DNR performing unit may output a refined sparse depth map by updating the sparse depth map with the refined depths of pixels.

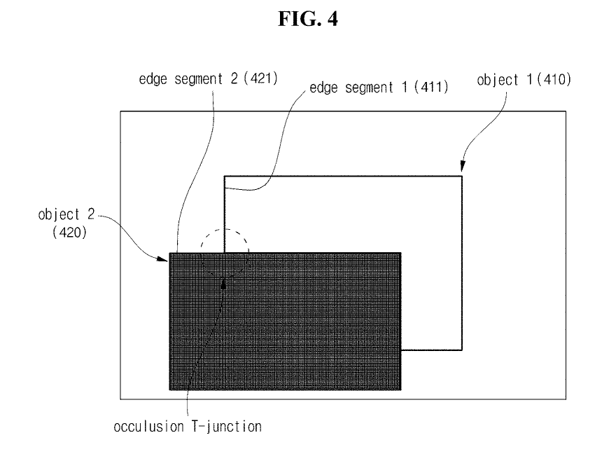

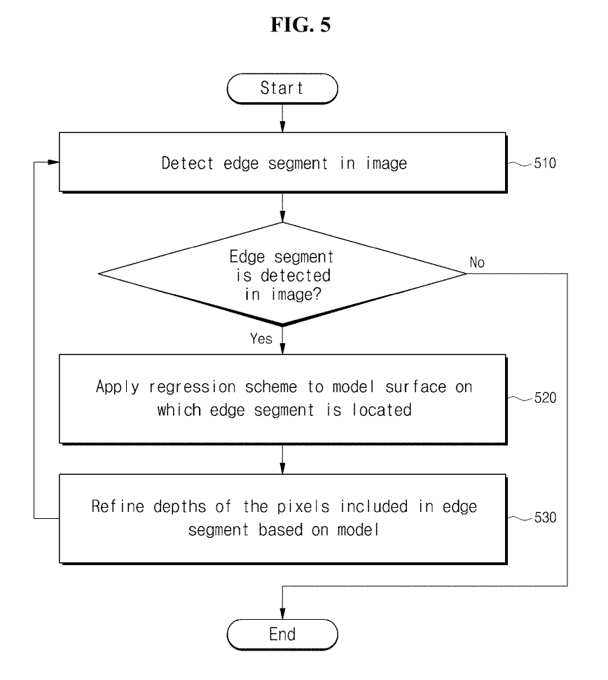

FIG. 4 is a view illustrating an edge segment for the purpose of describing the second DNR performing unit included in the DNR performing unit according to an embodiment. FIG. 5 is a flowchart illustrating an operation of the second DNR performing unit according to an embodiment.

Referring to FIGS. 4 and 5, the second DNR performing unit included in the DNR performing unit refines the depths of pixels included in edge segments 411 and 421 based on surface shapes of objects 410 and 420 at which the edge segments 411 and 421 included in the image are located.

In this case, the edge segments 411 and 421 represent a set of pixels located at a boundary at which boundaries and edges of the objects 410 and 420 included in the image are butted. Hereinafter, the butted region of the edge segments 411 and 421 represents an occlusion T-junction. For example, the occlusion T-junction represents a region in which the butting first edge segment 411 and the butted second edge segment 421 cross each other.

Therefore, since the pixels included in the same edge segment 411 or 421 are included in the same surface, the second DNR performing unit may refine the depths of pixels included in the edge segments 411 and 421 based on an equation related to a shape of the surface on which the edge segments 411 and 421 are located.

In this case, since the surface on which the edge segments 411 and 421 are located is either a curved or planner surface, the second DNR performing unit may model the surface, on which the edge segments 411 and 421 are located, into either a curved or planner surface.

In detail, the second DNR performing unit may detect the edge segments in the image in step 510, and by applying a regression scheme based on an equation related to a curved surface and an equation related to a planer surface in step 520 to model the surface on which the edge segments 411 and 421 are located, may refine the depths of the pixels included in the edge segments 411 and 421 based on the model in step 530.

For example, in step 520, the second DNR performing unit may model the surface on which the edge segments 411 and 421 are located to obtain the model by applying the regression scheme based on the number of pixels included in the edge segments 411 and 421.

In addition, in step 530, may refine the depths of pixels included in the edge segments 411 and 421 by amending the depths of pixels included in the edge segments 411 and 421 with reference to the values calculated from the equations (which are related to the curved and planer surfaces) related to the shape of the surface on which the edge segments (411 and 421) are located.

The equation related to a planer surface is expressed as following Equation 1.

z(x,y)=β₀+β₁x+β₂y [Equation 1]

Where z(x, y) is a depth of pixel (x, y), x and y are coordinates of a pixel, and β₀, β₁ and β₂ are constants defined on a planer surface.

In addition, the equation related to a curved surface is expressed as following Equation 2.

z(x,y)=β₀+β₁x+β₂y+β₃xy+β₄x²y+β₅x²+β₆xy²+β₇y² [Equation 2]

In Equation 2, z(x, y) is a depth of pixel (x, y), x and y are coordinates of a pixel, and β₀, β₁, β₂, β₃, β₄, β₅, β₆ and β₇ are constants defined on a planer surface.

The second DNR performing unit may repeat the above-described depth refinement operation for all edge segments included in the image.

For example, the second DNR performing unit detects the first edge segment 411 of the first object 410 in step 510, models the surface on which the first edge segment 411 is located in step 520, and refines the depths of the pixels included in the first edge segment 411 in step 530. Then, the second DNR performing unit may detect the second edge segment 421 of the second object 420 by performing step 510 again and then, may perform steps 520 and 530 for the second edge segment 421.

In this case, the second DNR may repeat the above-described depth refinement operation until any edge segments 411 and 421 are no longer detected in the image. Thus, when any edge segments 411 and 421 are no longer in the image, the second DNR performing unit may finish the above-described depth improvement operation.

In addition, the second DNR performing unit may update the sparse depth map with the refined depths of pixels included in the edge segments 411 and 421 so that the second DNR performing unit outputs a refined sparse depth map.

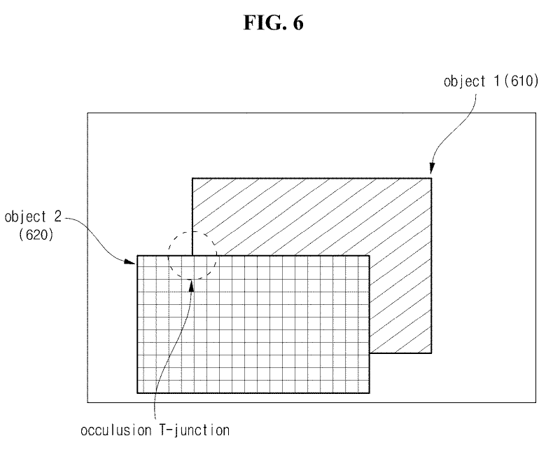

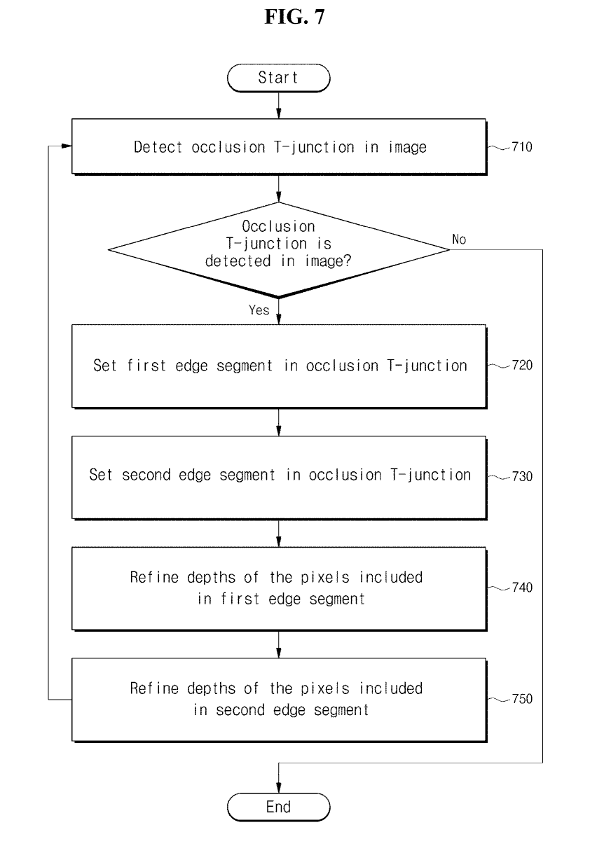

FIG. 6 is a view illustrating an edge segment for the purpose of describing the operation of the third DNR operating unit included in the DNR operating unit according to an embodiment. FIG. 7 is a flowchart illustrating the operation of the third DNR operating unit according to an embodiment.

Referring to FIGS. 6 and 7, the third DNR performing unit included in the DNR performing unit according to an embodiment refines the depths of the pixels included in the same surface based on depth ensembles in the pixels included in the same surface of the objects 619 and 620.

Although the second DNR performing unit described with reference to FIGS. 4 and 5 refines the depths of pixels included in an edge segment in consideration of only the edge segment, the third DNR performing unit refines depths of the pixels included in the same surface of the objects 610 and 620 by further taking into consideration the butt region of an edge segment.

In this case, the boundary may be determined through an occlusion T-junction which is a butt region of an edge segment. Thus, the third DNR performing unit distinguishes the edge segment included in the same surface based on the occlusion T-junction, so that the third DNR performing unit may use the depth ensembles in the pixels included in the same surface in the depth refinement step.

In detail the third DNR performing unit may detect an occlusion T-junction representing the butt region of the edge segment in an image in step 710, set all edge segments connected to the butting edge segment in the occlusion T-junction as a first edge segment located on the same surface in step 720, and set all edge segments connected to the butted edge segment in the occlusion T-junction as a second edge segment located on another same surface in step 730. In this case, the detecting of the occlusion T-junction represent the detecting of all edge segments included in the same surface. Thus, the first edge segment may include all edge segments included in the first object 610 and the second edge segment may include all edge segments included in the second object 620.

For example, in step 710, to determine the occlusion T-junction, the third DNR performing unit may compare the depths of the pixels included in the butted edge segment (for example, an edge segment corresponding to the second edge segment) and the butting edge segment (for example, an edge segment corresponding to the first edge segment) in the occlusion T-junction with each other.

In addition, in step 729, the third DNR performing unit may set all edge segments connected to the butting edge segment as the first edge segment located on the same surface, based on the space connectivity and similarity of the butting edge segment in the occlusion T-junction. In more detail, for example, the third DNR performing unit may assign a specific label to all edge segments connected to the butting edge segment so that the specific label assigned edge segments are set as the first edge segment.

Likewise, in step 730, the third DNR performing unit may set all edge segments connected to the butted edge segment as the second edge segment located on the same surface, based on the space connectivity and similarity of the butted edge segment in the occlusion T-junction. In more detail, for example, the third DNR performing unit may assign a specific label to all edge segments connected to the butted edge segment so that the specific label assigned edge segments are set as the second edge segment.

In other words, when two edges are spatially connected to each other and the depths of the pixels included in the two edges are similar to each other (in more advance, the neighborhoods of the pixels included in the two edges), it may be expressed that the two edges are connected to each other. In addition, the connection between two edges represents that the two edges are located on the same surface.

Therefore, in step 740, the third DNR performing unit may refine the depths of the pixels included in the first edge segment based on the depth ensembles in each pixel included in the first edge segment, and in step 70, may refine the depths of the pixels included in the second edge segment based on the depth ensembles in each pixel included in the second edge segment.

For example, the third DNR performing unit may refine the depths of the pixels included in the first edge segment by amending the depths of the pixels included in the first edge segment with reference to values based on the depth ensembles of each pixel included in the first edge segment.

In addition, the third DNR performing unit may refine the depths of the pixels included in the second edge segment by amending the depths of the pixels included in the second edge segment with reference to values based on the depth ensembles of each pixel included in the second edge segment.

The third DNR performing unit may repeat the above-described depth refinement operation for all occlusion T-junctions included in the image.

For example, the third DNR performing unit may detect the first occlusion T-junction in step 710, and refine the depths of the pixels included in the same surface by performing steps 720 to 750 for the first occlusion T-j unction. Then, the third DNR performing unit may detect the second occlusion T-junction by performing step 710 again and then, may perform steps 720 to 750 for the detected second occlusion T-junction.

In this case, the second DNR may repeat the above-described depth refinement operation until any occlusion T-junctions are no longer detected in the image. Thus, when any occlusion T-junctions are no longer detected in the image, the third DNR performing unit may finish the above-described depth improvement operation.

In addition, the third DNR performing unit may update the sparse depth map with the refined depths of the pixels included in the same surface so that the third DNR performing unit outputs a refined sparse depth map.

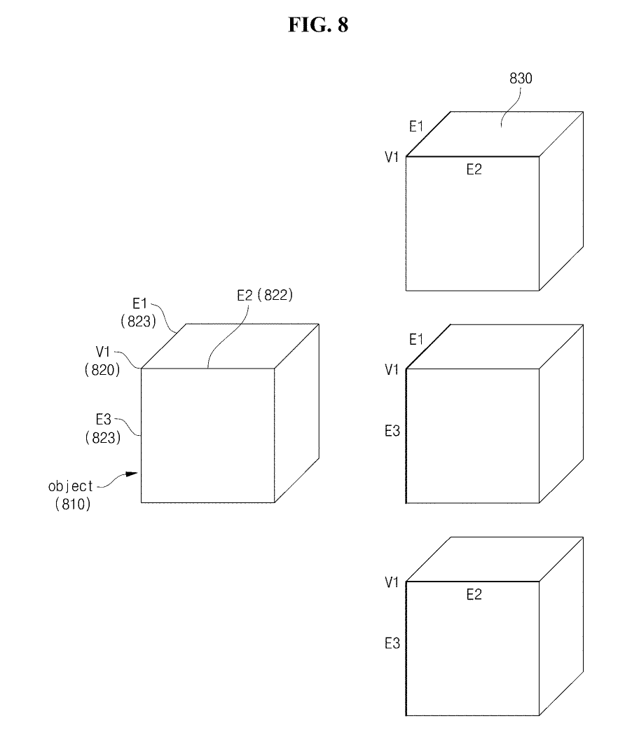

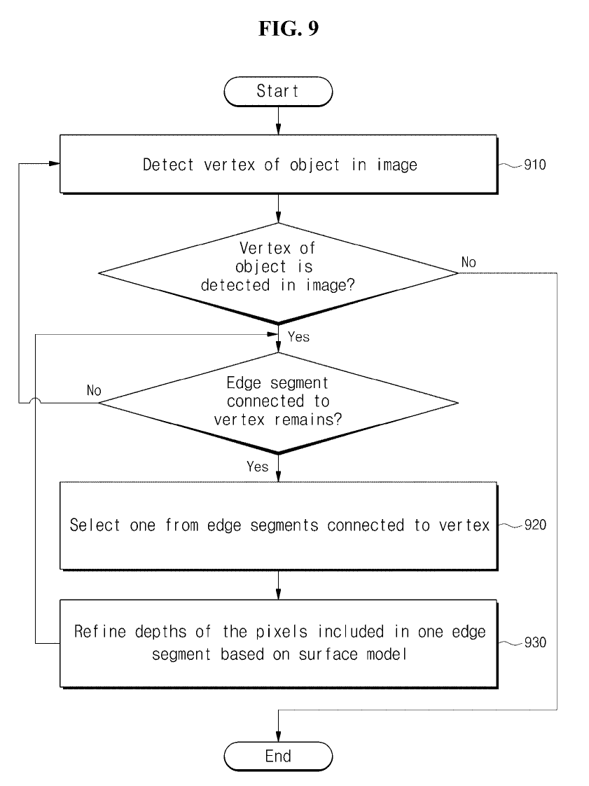

FIG. 8 is a view illustrating a third-dimensional object for the purpose of describing the fourth DNR performing unit included in the DNR performing unit according to an embodiment. FIG. 9 is a flowchart illustrating an operation of the fourth DNR performing unit according to an embodiment.

Referring to FIGS. 8 and 9, the fourth DNR performing unit included in the DNR performing unit refines the depths of the pixels included in edge segments 821, 822 and 823 located on an object 810 based on three-dimensional characteristics of the object 810.

In detail, the fourth DNR performing unit may detect a vertex 810 of an object in the image in step 910 and select one from the edge segments 821, 822 and 823 connected to the vertex 820 in step 920. Then, the fourth DNR performing unit may refine the depths of the pixels included in the selected edge segment based on a surface model of the object 810 formed of the edge segments 821, 822 and 823 connected to the vertex 820 in step 930.

In this case, since the vertex 820 represents a junction of the edge segments 821, 822 and 823, one of the edge segments 821, 822 and 823 may form a surface together with the other segments.

Thus, the fourth DNR performing unit may model the surface formed by the edge segments 821, 822 and 823 based on Equations 1 and 2 described above with reference to FIGS. 4 and 5.

Thus, in step 930, the fourth DNR performing unit may refine the depths of the pixels included one edge segment with reference to a depth value (estimated value) calculated through surface models (Equations 1 and 2).

For example, after selecting the first edge segment 821 from the edge segments 821, 822 and 823 connected to the vertex 820, the fourth DNR performing unit may refine the depths of the pixels included in the first edge segment 821 with reference to a depth value calculated from the surface model 830 formed through the first edge segment 821 and the second edge segment 822 connected to the first edge segment 821 and a depth value calculated from the surface model formed through the first edge segment 821 and the third edge segment 823 connected to the first edge segment 821.

Likewise, after selecting one from the remaining edge segments 822 and 823, the fourth DNR performing unit may refine the depths of the pixels included in the selected edge segment in the same manner.

That is, if N edge segments 821, 822 and 823 are connected to the vertex 820, (N-1) surface models may be taken into consideration in a process of refining the depths of the pixels included in each of N edge segments 821, 822 and 823 (for example, an average of depth values calculated from (N-1) surface models).

The fourth DNR performing unit may repeat the above-described depth refinement operation for all vertexes. In addition, the fourth DNR performing unit may repeat the above-described depth refinement operation for all edge segments 821, 822 and 823 connected to the vertex.

For example, after detecting the first vertex 820 in step 910, the fourth DNR performing unit repeats steps 920 and 930 for all edge segments connected to the first vertex 820, such that the fourth DNR performing unit refines the depths of the pixels included in each edge segment connected to the first vertex 820. Then, after detecting the second vertex in step 910 again, the fourth DNR performing unit may perform steps 920 and 930 for the detected second vertex.

In this case, likewise, the fourth DNR performing unit may repeat steps 920 and 930 for all edge segments connected to the second vertex.

Therefore, when any vertexes 820 of the object 810 detected in the image do not exist, the fourth DNR performing unit may finish the above-described depth improvement operation.

In addition, the fourth DNR performing unit may update the sparse depth map with the refined depths of the pixels included in the edge segment located at the object so that the fourth DNR performing unit outputs a refined sparse depth map.

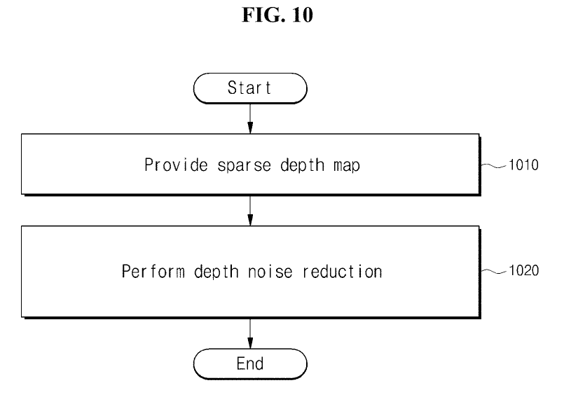

FIG. 10 is a flowchart illustrating a depth refinement method according to an embodiment.

Referring to FIG. 10, in step 1010, a depth refinement system provides a sparse depth map generated based on an image obtained through each of a plurality of apertures included in a multi-aperture camera, where the sparse depth map includes depths of the pixels included in the image.

Then, in step 1020, the depth refinement system performs a DNR based on the sparse depth map.

In detail, in step 1020, the depth refinement system may adaptively perform, through the DNR performing unit included in the depth refinement system, at least one of the steps of refining the depths of the pixels based on neighborhoods of the pixels included in the image, where the neighborhoods are values about the depths of neighborhood pixels adjacent to the pixels, refining the depths of the pixels included in an edge segment based on a surface shape of an object at which the edge segment included in the image is located, refining the depths of the pixels included in the same surface of the object based on depth ensembles in the pixels included in the same surface, and refining the depths of the pixels included in the edge segment which is located at the object based on three-dimensional characteristics of the object.

In this case, the step of refining the depths of the pixels based on neighborhoods of the pixels included in the image, where the neighborhoods are values about the depths of neighborhood pixels adjacent to the pixels, may be performed by the first DNR performing unit (see FIG. 3) included in the DNR performing unit. The step of refining the depths of the pixels included in an edge segment based on a surface shape of an object at which the edge segment included in the image is located may be performed by the second DNR performing unit (see FIGS. 4 and 5) included in the DNR performing unit. The step of refining the depths of the pixels included in the same surface of the object based on depth ensembles in the pixels included in the same surface may be performed by the third DNR performing unit (see FIGS. 6 and 7) included in the DNR performing unit. The step of refining the depths of the pixels included in the edge segment which is located at the object based on three-dimensional characteristics of the object may be performed by the fourth DNR performing unit (see FIGS. 8 and 9) included in the DNR performing unit.

Thus, each detailed step performed in step 1020 is the same as those described with reference to FIGS. 3 to 9.

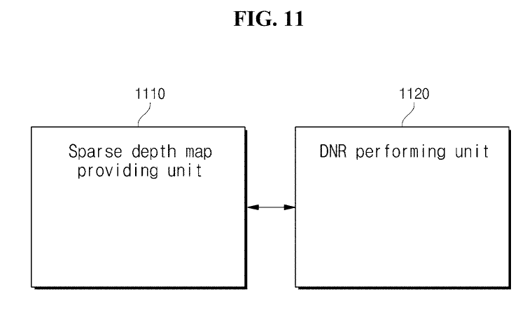

FIG. 11 is a block diagram illustrating a depth refinement system according to an embodiment.

Referring to FIG. 11, a depth refinement system according to an embodiment includes a sparse depth map providing unit 1110 and a DNR performing unit 1120.

The sparse depth map providing unit 1110 provides a sparse depth map generated based on an image obtained through each of a plurality of apertures included in a multi-aperture camera, where the sparse depth map includes depths of the pixels included in the image.

The DNR performing unit 1120 performs a DNR based on the sparse depth map.

In detail, although not shown, the DNR performing unit 1120 includes at least one of a first DNR performing unit for refining the depths of the pixels based on neighborhoods of the pixels included in the image, wherein the neighborhoods are values about depths of neighborhood pixels adjacent to the pixels, a second DNR performing unit for refining the depths of the pixels included in an edge segment based on a surface shape of an object at which the edge segment included in the image is located, a third DNR performing unit for refining depths of the pixels included in a same surface based on depth ensembles in the pixels included in the same surface of the object, and a fourth DNR performing unit for refining the depths of the pixels included in the edge segment which is located at the object based on three-dimensional characteristics of the object.

Thus, the DNR performing unit 1120 may perform the operation of at least one the first to fourth DNR performing units described with reference to FIGS. 3 to 9.

The embodiments may provide a technique of refine depths of pixels included in a sparse depth map by reducing a noise based on the sparse depth map.

In detail, the embodiments may provide a technique capable of refining depths of pixels based on at least one of neighborhoods of pixels, the surface shape of an object at which an edge segment including pixels, depth ensembles between pixels on the same surface, and three-dimensional characteristics of an object.

As described above, the embodiments of the inventive concept may provide a technique capable of reducing a noise by using perception cues based on a sparse depth map.

Therefore, the embodiments may prove a technique capable of refining depth qualities of each pixel included in a sparse depth map.

A number of exemplary embodiments have been described above. Nevertheless, it should be understood that various modifications may be made. For example, suitable results may be achieved if the described techniques are performed in a different order and/or if components in a described system, architecture, device, or circuit are combined in a different manner and/or replaced or supplemented by other components or their equivalents.

Accordingly, other implementations are within the scope of the following claims.

What is claimed is:

1. A method of refining depths of sparse depth images in a multi-aperture camera, the method comprising:
providing a sparse depth map generated based on an image obtained through each of a plurality of apertures included in the multi-aperture camera, wherein the sparse depth map includes depths of pixels included in the image; and
performing a depth noise reduction (DNR) based on the sparse depth map,
wherein the performing of the DNR comprises at least one of:
refining the depths of the pixels based on neighborhoods of the pixels included in the image, wherein the neighborhoods are values about depths of neighborhood pixels adjacent to the pixels;
refining depths of pixels included in an edge segment based on a surface shape of an object at which the edge segment included in the image is located;
refining depths of pixels included in a same surface based on depth ensembles in the pixels included in the same surface of the object; and
refining the depths of the pixels included in the edge segment which is located at the object based on three-dimensional characteristics of the object.

2. The method of claim 1, wherein the providing of the depths of the pixels comprises:
detecting the neighborhood of the pixels included in the image; and
applying a local or global manner to the depths of the pixels based on the detected neighborhoods to refine the depths of the pixels.

3. The method of claim 2, wherein the detecting of the neighborhoods of the pixels included in the image comprises estimating the neighborhoods of the pixels based on at least one of an average, a weighted average value, and a majority-voting value of the depths of the pixels and the neighborhood pixels.

4. The method of claim 1, wherein the refining of the depths of the pixels based on the surface shape of the object comprises:
detecting the edge segment in the image;
applying a regression scheme based on an equation related to a curved surface and an equation related to a planer surface to generate a model of a surface on which the edge segment is located; and
refining the depths of the pixels included in the edge segment based on the model.

5. The method of claim 1, wherein the refining of the depths of the pixels based on depth ensembles comprises:
detecting an occlusion T-junction representing a butt region of the edge segment in the image;
setting all edge segments connected to a butting edge segment in the occlusion T-junction as a first edge segment located on the same surface;
setting all edge segments connected to a butted edge segment in the occlusion T-junction as a second edge segment located on another same surface;
refining depths of pixels included in the first edge segment based on depth ensembles in each pixel included in the first edge segment; and
refining depths of pixels included in the second edge segment based on depth ensembles of each pixel included in the second edge segment.

6. The method of claim 5, wherein the detecting of the occlusion T-junction comprises comparing depths of the pixels included in the butted and butting edge segments in the occlusion T-junction with each other to determine the occlusion T-junction.

7. The method of claim 5, wherein the setting of the edge segments as the first edge segment comprises setting all edge segments connected to the butting edge segment as the first edge segment, based on space connectivity and similarity of the butting edge segment in the occlusion T-junction.

8. The method of claim 5, wherein the setting of the edge segments as the second edge segment comprises setting all edge segments connected to the butted edge segment as the second edge segment located on another same surface, based on space connectivity and similarity of the butted edge segment in the occlusion T-junction.

9. The method of claim 1, wherein the refining of the depths of the pixels based on the three-dimensional characteristics of the object comprises:
detecting a vertex of the object in the image;
selecting one from edge segments connected to the vertex; and
refining depths of the pixels included in the at least one edge segment based on a surface model of the object formed of the edge segments connected to the vertex.

10. The method of claim 9, wherein the surface model is modeled based on an equation related to a curved surface and an equation related to a planer surface.

11. A computer-readable recording medium comprising a program to instruct to a computer to perform claim 1.

12. A system for refining depths of sparse depth images in a multi-aperture camera, the system comprising:
a sparse depth map providing unit configured to provide a sparse depth map generated based on an image obtained through each of a plurality of apertures included in the multi-aperture camera, wherein the sparse depth map includes depths of pixels included in the image; and
a DNR performing unit configured to perform a depth noise reduction (DNR) based on the sparse depth map,
wherein the DNR performing unit comprises at least one of:
a first DNR performing unit configured to refine the depths of the pixels based on neighborhoods of the pixels included in the image, wherein the neighborhoods are values about depths of neighborhood pixels adjacent to the pixels;
a second DNR performing unit configured to refine depths of pixels included in an edge segment based on a surface shape of an object at which the edge segment included in the image is located;
a third DNR performing unit configured to refine depths of pixels included in a same surface based on depth ensembles in the pixels included in the same surface of the object; and
a fourth DNR performing unit configured to refine the depths of the pixels included in the edge segment which is located at the object based on three-dimensional characteristics of the object.

13. The system of claim 12, wherein the first DNR performing unit detects the neighborhood of the pixels included in the image and applies a local or global manner to the depths of the pixels based on the detected neighborhood to refine the depths of the pixels.

14. The system of claim 12, wherein the second DNR performing unit detects the edge segment in the image, applies a regression scheme based on an equation related to a curved surface and an equation related to a planer surface to generate a model of a surface on which the edge segment is located, and refines the depths of the pixels included in the edge segment based on the model.

15. The system of claim 12, wherein the third DNR performing unit detects an occlusion T-junction representing a butt region of the edge segment in the image, sets all edge segments connected to a butting edge segment in the occlusion T-junction as a first edge segment located on the same surface, sets all edge segments connected to a butted edge segment in the occlusion T-junction as a second edge segment located on another same surface, refines depths of the pixels included in the first edge segment based on depth ensembles in each pixel included in the first edge segment, and refines depths of the pixels included in the second edge segment based on depth ensembles in each pixel included in the second edge segment.

16. The system of claim 12, wherein the fourth DNR performing unit detects a vertex of the object in the image, selects one among edge segments connected to the vertex, and refines depths of the pixels included in the at least one edge segment based on a surface model of the object formed as the edge segments connected to the vertex.
